(19) United States
(12) Patent Application Publication
(10) Pub. No.: US 2016/0265779 A1
(43) Pub. Date: Sep. 15, 2016

(54) TWIN RADIAL SPLITTER-CHEVRON MIXER WITH CONVERGING THROAT

(71) Applicant: General Electric Company, Schenectady, NY (US)

(72) Inventors: Joel Meier HAYNES, Shenectady, NY (US); Narendra Digamber JOSHI, Schenectady, NY (US); David James WALKER, Burnt Hills, NY (US); Junwoo LIM, Lynn, MA (US); Sarah Marie MONAHAN, Latham, NY (US); Krishnakumar VENKATESAN, Clifton Park, NY (US)

(21) Appl. No.: 14/644,286

(22) Filed: Mar. 11, 2015

(51) Int. Cl. F23R 3/28; B01F 5/00; B01F 5/04; F23R 3/14; B01F 3/02

(52) U.S. Cl. CPC F23R 3/286; F23R 3/14; B01F 3/02; B01F 5/0403; B01F 5/0057

(57) ABSTRACT

A fuel nozzle for a gas turbine includes a first radial swirler and a second radial swirler that introduce radial swirl to a flow of pressurized air; a chevron splitter between the two swirlers that directs the swirled flow of pressurized air to a main mixer passage to form a fuel-air mixture with fuel injected into the fuel nozzle; and a main mixer passage that receives the fuel-air mixture from the premixing chamber, and includes a converging throat that accelerates the fuel-air mixture. A method of mixing fuel and air for combustion in a gas turbine includes introducing a radial swirl to first and second flows of pressurized air; directing the swirled, pressurized air to a premixing chamber via a chevron splitter; mixing the swirled, pressurized air with a fuel jet injected into the premixing chamber to form a fuel-air mixture; and accelerating the fuel-air mixture in the main mixer passage having a converging throat.

### BACKGROUND

The present technology relates generally to combustors and, more particularly, to fuel-air mixers of lean-premixed combustors for use in low-emission combustion processes.

The extraction of energy from fuels has been carried out in combustors with diffusion-controlled (i.e. non-premixed) combustion where the reactants are initially separated and reaction occurs only at the interface between the fuel and oxidizer, where mixing and reaction both take place. Examples of such devices include, but are not limited to, aircraft gas turbine engines and aero-derivative gas turbines for applications in power generation, marine propulsion, gas compression, cogeneration, and offshore platform power to name a few. In designing such combustors, engineers are not only challenged with persistent demands to maintain or reduce the overall size of the combustors, to increase the maximum operating temperature, and to increase specific energy release rates, but also with an ever increasing need to reduce the formation of regulated pollutants and their emission into the environment. Examples of the main pollutants of interest include oxides of nitrogen (NOx), carbon monoxide (CO), unburned and partially burned hydrocarbons, and greenhouse gases, such carbon dioxide (CO₂). Because of the difficulty in controlling local composition variations in the flow due to the reliance on fluid mechanical mixing while combustion is taking place, peak temperatures associated with localized stoichiometric burning, residence time in regions with elevated temperatures, and oxygen availability, diffusion combustors offer a limited capability to meet current and future emission requirements while maintaining the desired levels of increased performance.

Recently, lean-premixed combustors have been used to further reduce the levels of emission of undesirable pollutants. In these combustors, proper amounts of fuel and oxidizer are well mixed in a mixing chamber or region by use of a fuel-air mixer prior to the occurrence of any significant chemical reaction in the combustor, thus facilitating the control of the above-listed difficulties of diffusion combustors and others known in the art. Conventional fuel-air mixers of premixed burners incorporate sets of inner and outer counter-rotating swirlers disposed generally adjacent an upstream end of a mixing duct for imparting swirl to an air stream. Different ways to inject fuel in such devices are known, including supplying a first fuel to the inner and/or outer annular swirlers, which may include hollow vanes with internal cavities in fluid communication with a fuel manifold in the shroud, and/or injecting a second fuel into the mixing duct via cross jet flows by a plurality of orifices in a center body wall in flow communication with a second fuel plenum. In such devices, high-pressure air from a compressor is injected into the mixing duct through the swirlers to form an intense shear region and fuel is injected into the mixing duct from the outer swirler vane passages and/or the center body orifices so that the high-pressure air and the fuel is mixed before a fuel/air mixture is supplied out the downstream end of the mixing duct into the combustor, ignited, and combusted.

Because of the cross jet flow and localized fuel injection points and the way the swirl is imparted, fuel concentrations in conventional fuel-air mixers are highest near the mixer walls at an exit plane, thus preventing the control of the local variation of fuel concentration at the exit of the mixing duct, particularly when considering the need for combustors capable of operating properly with a wide range of fuels, including, but not limited to, natural gas, hydrogen, and synthesis fuel gases (also known as syngas), which are gases rich in carbon monoxide and hydrogen obtained from gasification processes of coal or other materials. Therefore, the fuel concentration profile delivered to the flame zone may contain unwanted spatial variations, thus minimizing the full effect of premixing on the pollutant formation process as well as possibly affecting the overall flame stability in the combustion zone.

A need exists for a fuel-air mixer for use in lean-premixed combustors having enhanced capabilities to control the local variation of fuel concentration at an exit thereof while maintaining control of flow separation and flame holding in the mixing duct. This increased control will permit the development of premixing devices having a reduced length without substantially affecting the overall pressure drop in the device.

### BRIEF DESCRIPTION

In accordance with one example of the technology disclosed herein, a fuel nozzle for a gas turbine comprises a first radial swirler and a second radial swirler that introduce radial swirl to a flow of pressurized air; a chevron splitter between the two swirlers that directs the swirled flow of pressurized air to a main mixer passage to form a fuel-air mixture with fuel injected into the fuel nozzle; and a main mixer passage that receives the fuel-air mixture from the premixing chamber, and includes a converging throat that accelerates the fuel-air mixture.

In accordance with another example of the technology disclosed herein, a method of mixing fuel and air for combustion in a gas turbine comprises introducing a radial swirl to first and second flows of pressurized air; directing the swirled, pressurized air to a premixing chamber via a mixer; mixing the swirled, pressurized air with a fuel jet injected into the premixing chamber to form a fuel-air mixture; and accelerating the fuel-air mixture in the main mixer passage having a converging throat

### DRAWINGS

These and other features, aspects, and advantages of the present technology will become better understood when the following detailed description is read with reference to the accompanying drawings in which like characters represent like parts throughout the drawings, wherein:

FIG. 1 is a block diagram of a turbine system having fuel nozzles coupled to a combustor in accordance with an embodiment of the present technology;

FIG. 2 is a partial cross-sectional view of a fuel-air mixer in accordance with aspects of the present technology; and

FIG. 3 is an end view of a corrugated chevron splitter of the fuel-air mixer of FIG. 2.

### DETAILED DESCRIPTION

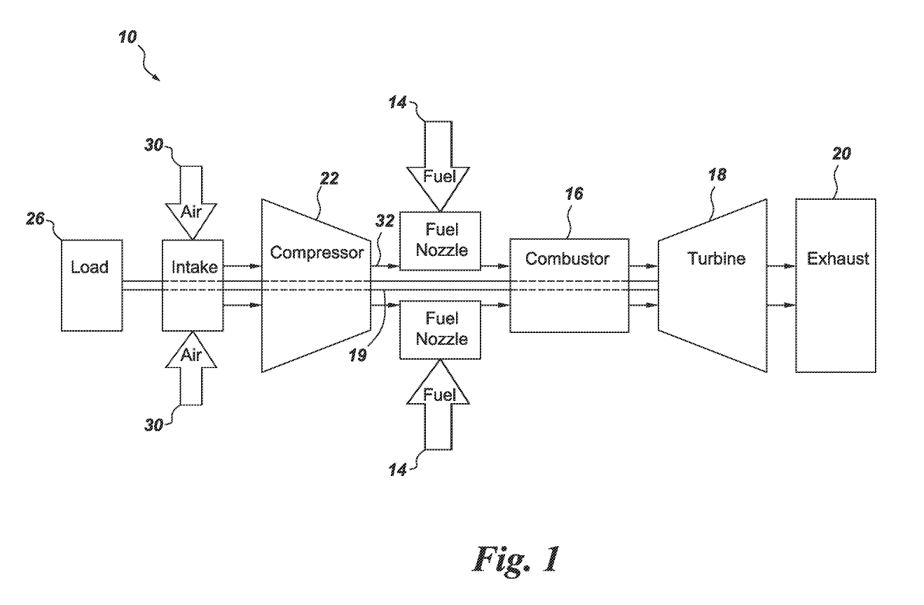

Referring to FIG. 1, a gas turbine system 10 includes a fuel nozzle 12, a fuel supply 14, and a combustor 16. The fuel supply 14 routes a liquid fuel or gas fuel, such as natural gas, to the turbine system 10 through the fuel nozzle 12 into the combustor 16. As discussed in more detail below, the fuel nozzle 12 is configured to inject and mix the fuel with compressed air to form an air-fuel mixture. The combustor 16 ignites and combusts the fuel-air mixture, and then passes hot pressurized exhaust gas into a turbine 18. The exhaust gas passes through turbine blades in the turbine 18, thereby driving the turbine 18 to rotate. In turn, the coupling between blades in turbine 18 and a shaft 19 will cause rotation of the shaft 19, which is also coupled to several components throughout the turbine system 10. Eventually, the exhaust of the combustion process may exit the turbine system 10 via exhaust outlet 20.

Vanes or blades of the compressor 22 may be coupled to the shaft 19 and will rotate as shaft 19 is driven to rotate by turbine 18. The compressor 22 may intake air to turbine system 10 via air intake 24. The shaft 19 may be coupled to load 26, which may be powered via rotation of shaft 19. The load 26 may be any device that generates power via the rotational output of the turbine system 10, such as a power generation plant or an external mechanical load. For example, the load 26 may include an electrical generator, a propeller of an airplane, and so forth. The air intake 24 draws air 30 into turbine system 10 via a suitable mechanism, such as a cold air intake, for subsequent mixture of air 30 with fuel supply 14 via the fuel nozzle 12. As will be discussed in detail below, air 30 taken in by turbine system 10 may be fed and compressed into pressurized air by rotating blades within compressor 22. The pressurized air 32 may then be fed into fuel nozzle 12. The fuel nozzle 12 may then mix the pressurized air 32 and fuel 14 to produce a fuel-air mixture 34 at a mix ratio for combustion, e.g., a combustion that causes the fuel to more completely burn, so as not to waste fuel or cause excess emissions. An example of the turbine system 10 includes certain structures and components within fuel nozzle 12 to improve the air fuel mixture, thereby increasing performance and reducing emissions.

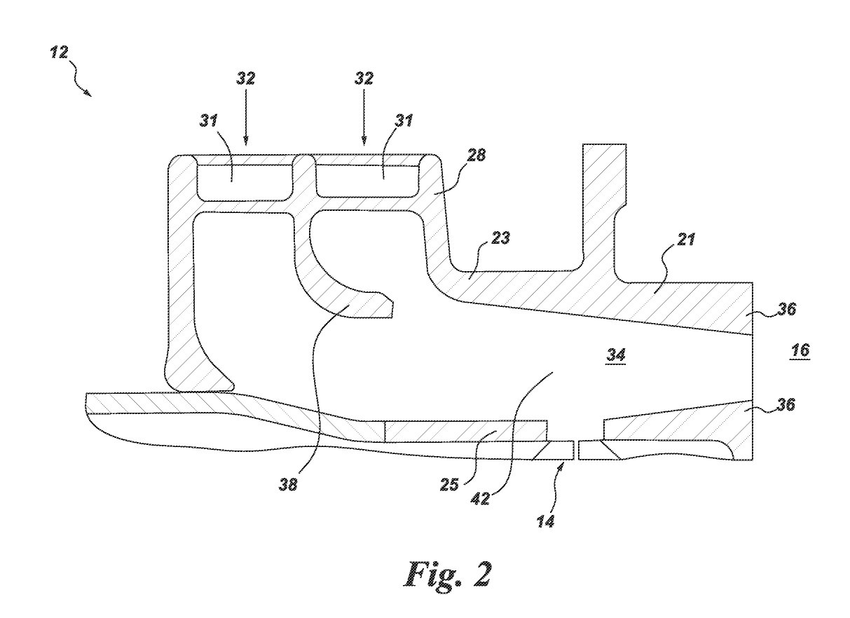

Referring to FIG. 2, the fuel nozzle 12 includes two radial air swirlers 31 that receive the pressurized air 32 and introduce a radial swirl to the pressurized air 32. The radial air swirlers 31 are provided axially side-by-side (i.e. along the longitudinal axis of the turbine system 10). The radial air swirlers 31 direct the swirled, pressurized air to a chevron splitter 38. The radial air swirlers 31 may swirl the pressurized air 32 in the same rotational direction or the swirlers 31 may swirl the pressurized air 32 in counter rotational directions.

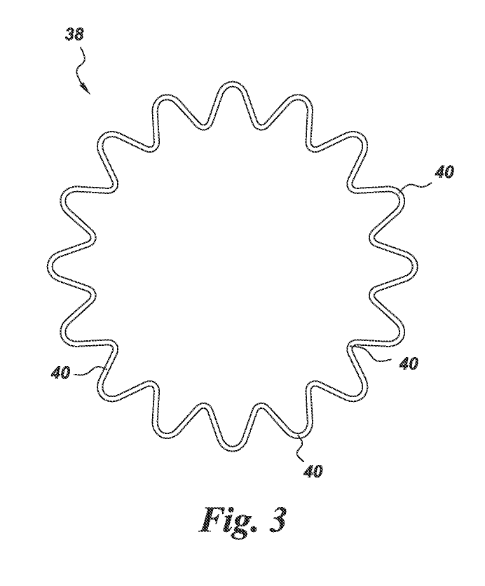

As shown in FIGS. 2 and 3, the chevron splitter 38 may be corrugated and have alternating ridges and grooves 40. As shown in FIG. 2, the main mixer passage 42 is located between an inner wall 25 and an outer wall 23 of the main mixer passage 42 to enhance mixing of the swirled, pressurized air 32 and the fuel jet 14 to reduce NOx. The swirled, pressurized air 32 and the fuel jet 14 are premixed in a main mixer passage 42. The corrugations 40 of the chevron splitter 38 introduce turbulence at a radial and axial location to break up the fuel jet 14 and mix it with the incoming swirled, pressurized air 32. The corrugations may be designed to impart a high turbulence intensity to the fuel-air mixture 34 in the main mixer passage 42.

The main mixer passage 42 includes a converging throat 36 that reduces the flow area of the mixer passage 42 and accelerates the flow of the fuel-air mixture 34 and attenuates the effects of the corrugations 40 of the chevron splitter 38 on the combustion process. This allows larger corrugations 40 to be used to enhance the premixing of the fuel jet 14 and the swirled, pressurized air 32. The corrugations 40 may be designed to provide at least half the turbulence intensity of the fuel-air mixture 34 within the converging throat 36. The acceleration of the fuel-air mixture 34 reduces the boundary layer of the fuel-air mixture 34 on the walls of the converging throat 36 and reduces the residence time of the fuel-air mixture 34 in the main mixer passage 42 prior to exiting into the combustor 16. The reduction in the boundary layer also reduces the possibility of the flame in the combustor 16 from travelling back into the main mixer passage 42 and the center body 25 of the fuel nozzle. It should also be appreciated that alternating ridges and grooves, similar to those of the chevron splitter 38, may be provided on the inner wall of the main mixer lip 21, including the end of the converging section 36.

The radial swirlers 31 and the corrugations 40 of the chevron splitter 38 provide rapid mixing of the fuel and air prior to combustion. Premixing reduces peak flame temperatures by leaning out some of the fuel-air mixture below the stoichiometric fuel air ratio. NOx formation rates are driven by high temperatures under the Zeldovich mechanism; hence, premixing of fuel and air reduces thermal NOx formation by the Zeldovich mechanism. Emission standards set limits on NOx emission from gas turbines and a low NOx combustor is better able to meet the emission standards and could allow a more efficient gas turbine cycle (higher pressures) to be used. The converging throat reduces fluid communication between the premixing chamber and the combustion chamber which will reduce instabilities driven by the premixer.

It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the present technology have been illustrated and described herein, many modifications and changes will occur to those skilled in the art. It is therefore to be understood that the appended claims are intended to cover all such modifications and changes.

1. A fuel nozzle for a gas turbine, comprising:
a first radial swirler and a second radial swirler that introduce radial swirl to a flow of pressurized air;
a chevron splitter between the two swirlers that directs the swirled flow of pressurized air to a main mixer passage to form a fuel-air mixture with fuel injected into the fuel nozzle; and
a main mixer passage that receives the fuel-air mixture from the premixing chamber, and includes a converging throat that accelerates the fuel-air mixture.

2. The fuel nozzle of claim 1, wherein the first and second radial swirlers are side-by-side in an axial direction of the fuel nozzle.

3. The fuel nozzle of claim 1, wherein the first and second radial swirlers impart counter radial swirls to the flow of pressurized air.

4. The fuel nozzle of claim 1, wherein the chevron splitter and mixer outer lip are corrugated.

5. The fuel nozzle of claim 4, wherein the chevron splitter creates a turbulent fuel-air mixture.

6. The fuel nozzle of claim 5, wherein at least half of the turbulence intensity of the fuel-air mixture is located in the converging throat of the main mixer passage.

7. A method of mixing fuel and air for combustion in a gas turbine, comprising:
introducing a radial swirl to first and second flows of pressurized air;
directing the swirled, pressurized air to a premixing chamber via a chevron splitter;
mixing the swirled, pressurized air with a fuel jet injected into the premixing chamber to form a fuel-air mixture; and
accelerating the fuel-air mixture in the main mixer passage having a converging throat.

8. The method according to claim 7, wherein the first and second flows of pressurized air are side-by-side in an axial direction of the premixing chamber.

9. The method of claim 7, wherein the chevron splitter and a mixer outer lip are corrugated and cause the mixing of the swirled, pressurized air and the fuel jet to be turbulent.

10. The method of claim 9, wherein at least half of the turbulence intensity of the fuel-air mixture is located in the converging throat of the main mixer passage.

11. The method of claim 7, wherein the first and second flows of pressurized air are counter swirled.
